(19) United States
(12) Patent Application Publication
(10) Pub. No.: US 2014/0032626 A1
(43) Pub. Date: Jan. 30, 2014

(54) MULTIPLY ACCUMULATE UNIT ARCHITECTURE OPTIMIZED FOR BOTH REAL AND COMPLEX MULTIPLICATION OPERATIONS AND SINGLE INSTRUCTION, MULTIPLE DATA PROCESSING UNIT INCORPORATING THE SAME

(71) Applicant: Stephen E. Jarboe, Carrollton, TX (US)

(72) Inventor: Stephen E. Jarboe, Carrollton, TX (US)

(73) Assignee: VeriSilicon Holdings Co., Ltd., Plano, TX (US)

(21) Appl. No.: 13/559,339

(22) Filed: Jul. 26, 2012

(51) Int. Cl. G06F 7/523

(52) U.S. Cl. 708/622; 708/620

(57) ABSTRACT

A multiply-accumulate unit (MAU) configurable to perform both real and complex multiplication operations, a method of performing a mac operation and a processing unit incorporating the MAU or the method. In one embodiment, the MAU includes: (1) a first multiplier having a first vector input and a first scalar input and configured to multiply a first vector by a first scalar to yield a first product, (2) a second multiplier having a second vector input and a second scalar input and configured to multiply a second vector by a second scalar to yield a second product and (3) an accumulator coupled to the first multiplier and the second multiplier and configured to receive the first and second products.

### TECHNICAL FIELD

This application is directed, in general, to computer processors and, more specifically, to a single instruction, multiple data (SIMD) processing unit having real and complex data multiplication capability.

### BACKGROUND

The multiplication of two real numbers in a computer processor involves two inputs and therefore requires one multiplier. In contrast, the multiplication of two complex numbers in a computer processor involves four inputs (i.e., both the real and imaginary parts of the two complex numbers) and requires four multipliers. A complex multiplication requires twice as many multipliers per data input as a real multiplication, because each complex part is involved in two multiplications.

Given two real numbers, a and b, real multiplication is a×b. Given two complex numbers, a′=a.re+ja.im and b′=b.re+jb.im, complex multiplication is:

(a.re+ja.im)×(b.re+jb.im)=[(a.re×b.re)−(a.im×b.im)]+j[(a.re×b.im)+(a.im×b.re)].

A multiply-accumulate (mac) operation is a combination of the above-described multiplication, followed by the addition of the product to another value. It is quite common in signal processing. A vector input X contains multiple a or a′ values, and a vector input Y contains multiple b or b′ values. Each element of X is multiplied with each element of Y to yield a product Z, viz.:

Z[i]+=X[i]*Y[i].

Conventional SIMD processing units keep the vector inputs and the multipliers in corresponding sets of lanes. Different conventional approaches have been used to compute a complex mac in such processing units. A simpler but slower approach is to reuse a single multiplier four times with different inputs. A faster approach is to provide both X and Y into a four-multiplier array.

### SUMMARY

One aspect provides a multiply-accumulate unit (MAU) configurable to perform both real and complex multiplication operations. In one embodiment, the MAU includes: (1) a first multiplier having a first vector input and a first scalar input and configured to multiply a first vector by a first scalar to yield a first product, (2) a second multiplier having a second vector input and a second scalar input and configured to multiply a second vector by a second scalar to yield a second product and (3) an accumulator coupled to the first multiplier and the second multiplier and configured to receive the first and second products.

Another aspect provides a method of performing a mac operation. In one embodiment, the method includes: (1) using a first multiplier having a first vector input and a first scalar input to multiply a first vector by a first scalar to yield a first product, (2) using a second multiplier having a second vector input and a second scalar input to multiply a second vector by a second scalar to yield a second product and (3) receiving the first and second products in a first accumulator coupled to the first multiplier and the second multiplier.

Yet another aspect provides a processing unit. In one embodiment, the processing unit includes: (1) a pipeline control unit, (2) register files coupled to the pipeline control unit, (3) a load/store unit coupled to the register files and (4) a multiply-accumulate unit configurable to perform both real and complex multiplication operations. In one embodiment, the MAU includes: (4a) a first multiplier having a first vector input and a first scalar input and configured to multiply a first vector by a first scalar to yield a first product, (4b) a second multiplier having a second vector input and a second scalar input and configured to multiply a second vector by a second scalar to yield a second product and (4c) an accumulator coupled to the first multiplier and the second multiplier and configured to receive the first and second products.

### BRIEF DESCRIPTION

Reference is now made to the following descriptions taken in conjunction with the accompanying drawings, in which:

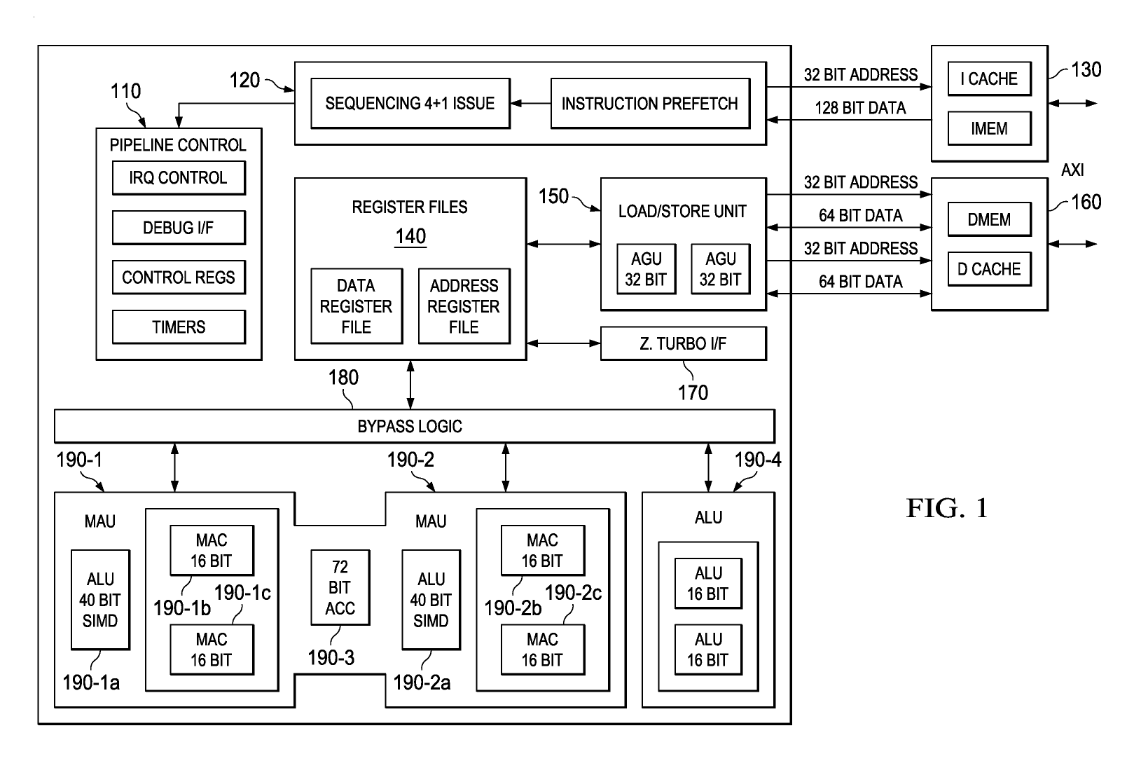

FIG. 1 is a block diagram of one embodiment of a SIMD processing unit including at least one MAU having a novel architecture;

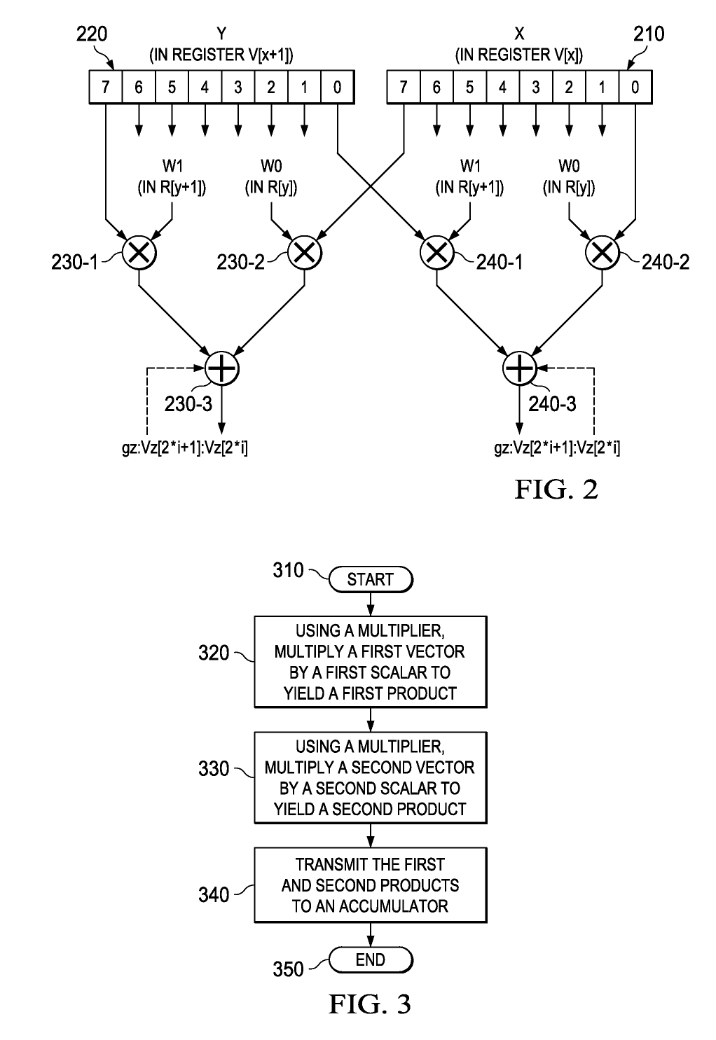

FIG. 2 is a diagram of multipliers in a MAU of FIG. 1; and

FIG. 3 is a flow diagram of one embodiment of a method of performing a mac operation.

### DETAILED DESCRIPTION

As stated above, the faster conventional approach is to provide both X and Y (two vectors taking the form of data words) into a four-multiplier array. Unfortunately, conventional SIMD processing units provide only these two vectors to the multiplier array. While this is efficient for a complex mac operation, it is inefficient for a real mac operation because X and Y then contain only enough data input for two of the four multipliers.

One simple solution to increase the efficiency of real mac operations is to pack twice the data in X and Y and perform two mac operations concurrently. Unfortunately, this then makes complex mac operations inefficient.

Introduced herein is a MAU constructed according to a novel architecture that is optimized to use all multipliers in both real and complex mac operations. Instead of providing only vector inputs X and Y and multiplying each element of X by each element of Y as described above, the architecture incorporates a third, scalar input (e.g., “W”), which is narrower than X or Y. According to the architecture, a real mac operation involves multiplying a first vector by a first scalar and a second vector by a second scalar and then accumulating the products of the two multiplications. In a MAU embodiment employing a four-multiplier array, the scalar input W provides two scalar values WO and Wl as opposed to the larger widths of X and Y. All elements of the vector X are multiplied by WO, all elements of Y are multiplied by Wl, and the products of the two multiplications are then accumulated, viz.:

Z+=X[i]*WO+Y[i]*Wl

In an alternative embodiment, a difference is derived between the products of the two multiplications. In another alternative embodiment, the products of the two multiplications are subtracted from, rather than added to, an accumulated value.

Because it is narrow relative to the X and Y inputs, an additional data port to accommodate the additional scalar input W adds little cost to the architecture. Further, the novel architecture exhibits little mismatch between data bandwidth available and multiplier resources.

A MAU employing the novel architecture can provide significantly greater performance than (e.g., twice the performance of) a conventional MAU when used in finite impulse response (FIR) filters, matrix multiplication, and other real-valued signal processing functions.

In one embodiment, X and Y are consecutive registers. However, those skilled in the pertinent art will understand that X and Y may be nonconsecutive registers. W can come from a number of different sources.

FIG. 1 is a block diagram of one embodiment of a SIMD processing unit including at least one MAU having the novel architecture described above. The SIMD processing unit includes a pipeline control unit 110 that receives prefetched and sequenced instructions from a prefetch unit 120, which, in turn, communicates with an instruction cache and memory 130. Register files 140, used to store both data and addresses, are coupled to a load/store unit 150, which, in turn, is coupled to a data cache and memory 160 and a turbo interface 170. The turbo interface 170 allows user-defined logic to be connected to the SIMD processing unit.

The register files 140 are likewise coupled to bypass logic 180. The bypass logic is coupled to circuitry configured to perform mathematical and logical operations on constants or data stored in the register file 140 or the data cache and memory 160. The circuitry includes first and second MAUs 190-1, 190-2. The first MAU 190-1 includes an arithmetic and logic unit (ALU) 190-1a and first and second multipliers/accumulators (MACs) 190-1b, 190-1c. The second MAU 190-2 includes an ALU 190-2a and first and second MACs 190-2b, 190-2c. Another accumulator 190-3 is configured to accumulate results from the first and second MAUs 190-1, 190-2. An ALU 190-4 is likewise coupled to the bypass logic 180. One alternative embodiment employs a single MAU having SIMD capabilities. Another alternative embodiment employs an MAU having only two multipliers. Yet another alternative embodiment employs an MAU having a single multiplier that is reused as needed.

It should be noted that the SIMD processing unit of FIG. 1 has eight lanes for the multiple data it is to process according to each, single instruction. Accordingly, the register files 140, the first and second MAUs 190-1, 190-2, the accumulator 190-3 and the ALU 190-4 are divided into portions dedicated to each of the eight lanes. For clarity's sake, FIG. 1 does not show the register files 140, the first and second MAUs 190-1, 190-2, the accumulator 190-3 and the ALU 190-4 divided into these portions. Those skilled in the pertinent art will understand that the number of lanes may vary without departing from the broad scope of the invention.

In the embodiment of FIG. 1, both the MAU 190-1 and the MAU 190-2 are constructed according to the novel architecture disclosed herein. In an alternative embodiment, only one of the MAU 190-1 and the MAU 190-2 is constructed according to the novel architecture. In another embodiment, the SIMD processing unit includes one or more further MAUs constructed according to the novel architecture.

FIG. 2 is a diagram of multipliers in the MAU of FIG. 1. FIG. 2 illustrates a real mac operation performed in one or more MAUs having, in this example, 16 multipliers. The outputs of first and second multipliers 230-1, 230-2 are coupled to the input of an accumulator 230-3. The outputs of third and fourth multipliers 240-1, 240-2 are coupled to the input of an accumulator 240-3. In the embodiment of FIG. 2, the accumulators 230-3, 240-3, are separate accumulators. In an alternative embodiment, the accumulators 230-3, 240-3 constitute a single accumulator.

The first multiplier 230-1 has both a Y (vector) input and a W1 (scalar) input. The Y (vector) and W1 (scalar) inputs are employed in a real mac operation. The first multiplier 230-1 has an additional X (vector) input that is not shown but employed in a complex mac operation. The second multiplier 230-2 has both an X (vector) input and a W0 (scalar) input. The second multiplier 230-2 has an additional Y (vector) input that is not shown but employed in a complex mac operation. The results (products) of the multiplications performed in the first and second multipliers 230-1, 230-2 are accumulated in an accumulator 230-3. The third multiplier 240-1 has both a Y (vector) input and a W1 (scalar) input. The third multiplier 240-1 has an additional X (vector) input that is not shown but employed in a complex mac operation. The fourth multiplier 240-2 has both an X (vector) input and a W0 (scalar) input. The fourth multiplier 240-2 has an additional Y (vector) input that is not shown but employed in a complex mac operation. The results (products) of the multiplications performed in the third and fourth multipliers 240-1, 240-2 are accumulated in an accumulator 240-3.

In the embodiment of FIG. 2, the X input is provided by one of the registers contained in the register files 140 of FIG. 1 (e.g., lanes 0 and 7 of register V[x] 210), and the Y input is provided by a consecutive one of the registers (e.g., lanes 0 and 7 of register V[x+1] 220). Also in the embodiment of FIG. 2, the W0 (scalar) input is provided by one of the registers contained in the register files 140 of FIG. 1 (e.g., register R[y]), and the W1 (scalar) input is provided by a consecutive one of the registers (e.g., register R[y+1]). As is evident in FIG. 2, the (e.g., cumulative) output of the accumulators 230-3, 240-3 are stored in another register (e.g., a register V[z]).

FIG. 3 is a flow diagram of one embodiment of a method of performing a mac operation. The method begins in a start step 310. In a step 320, using a multiplier, a first vector is multiplied by a first scalar to yield a first product. In a step 330, using a multiplier (which may be the same or another multiplier), a second vector is multiplied by a second scalar to yield a second product. In a step 340, the first and second products are transmitted to an accumulator. The accumulator may add the first and second products to an existing value in the accumulator. Alternatively, the accumulator may derive a difference between the first and second products. Further alternatively, the accumulator may subtract the first and second products from the existing value in the accumulator. The method ends in an end step 350.

Those skilled in the art to which this application relates will appreciate that other and further additions, deletions, substitutions and modifications may be made to the described embodiments.

What is claimed is:

1. A multiply-accumulate unit configurable to perform both real and complex multiplication operations, comprising:
a first multiplier having a first vector input and a first scalar input and configured to multiply a first vector by a first scalar to yield a first product;
a second multiplier having a second vector input and a second scalar input and configured to multiply a second vector by a second scalar to yield a second product; and
an accumulator coupled to said first multiplier and said second multiplier and configured to receive said first and second products.

2. The multiply-accumulate unit as recited in claim 1 wherein said first multiplier and said second multiplier are separate multipliers respectively configured concurrently to multiply said first vector by said first scalar and said second vector by said second scalar.

3. The multiply-accumulate unit as recited in claim 1 wherein said multiply-accumulate unit is a first multiply-accumulate unit and is associated with a second multiply-accumulate unit that includes:
a first multiplier having a first vector input and a first scalar input and configured to multiply a first vector by a first scalar to yield a first product;
a second multiplier having a second vector input and a second scalar input and configured to multiply a second vector by a second scalar to yield a second product; and
an accumulator coupled to said first multiplier and said second multiplier and configured to receive said first and second products.

4. The multiply-accumulate unit as recited in claim 3 further comprising an accumulator coupled to said first and second multiply-accumulate units.

5. The multiply-accumulate unit as recited in claim 1 wherein said first and second multipliers are divided into portions dedicated to separate lanes of a processing unit.

6. The multiply-accumulate unit as recited in claim 1 wherein said accumulator is configured to add said first and second products to an existing value in said accumulator.

7. The multiply-accumulate unit as recited in claim 1 wherein said multiply-accumulate unit is associated with a single-instruction multiple data processing unit.

8. A method of performing a mac operation, comprising:
using a first multiplier having a first vector input and a first scalar input to multiply a first vector by a first scalar to yield a first product;
using a second multiplier having a second vector input and a second scalar input to multiply a second vector by a second scalar to yield a second product; and
receiving said first and second products in a first accumulator coupled to said first multiplier and said second multiplier.

9. The method as recited in claim 8 wherein said using said first multiplier and said using said second multiplier are carried out concurrently.

10. The method as recited in claim 8 further comprising:
using a third multiplier having a third vector input and a third scalar input to multiply a third vector by a third scalar to yield a third product;
using a fourth multiplier having a fourth vector input and a fourth scalar input to multiply a fourth vector by a fourth scalar to yield a fourth product; and
receiving said third and fourth products in a second accumulator coupled to said third multiplier and said fourth multiplier.

11. The method as recited in claim 10 further comprising receiving said first, second third and fourth products in a further accumulator.

12. The method as recited in claim 8 wherein said first and second multipliers are divided into portions dedicated to separate lanes of a processing unit.

13. The method as recited in claim 8 wherein said first accumulator is configured to add said first and second products to an existing value in said first accumulator.

14. The method as recited in claim 8 wherein said method is carried out in a single-instruction multiple data processing unit.

15. A processing unit, comprising:
a pipeline control unit;
register files coupled to said pipeline control unit;
a load/store unit coupled to said register files; and
a multiply-accumulate unit configurable to perform both real and complex multiplication operations, including:
a first multiplier having a first vector input and a first scalar input and configured to multiply a first vector by a first scalar to yield a first product,
a second multiplier having a second vector input and a second scalar input and configured to multiply a second vector by a second scalar to yield a second product, and
an accumulator coupled to said first multiplier and said second multiplier and configured to receive said first and second products.

16. The processing unit as recited in claim 15 wherein said first multiplier and said second multiplier are separate multipliers respectively configured concurrently to multiply said first vector by said first scalar and said second vector by said second scalar.

17. The processing unit as recited in claim 15 wherein said multiply-accumulate unit is a first multiply-accumulate unit and said processing unit further comprises:
a second multiply-accumulate unit including:
a first multiplier having a first vector input and a first scalar input and configured to multiply a first vector by a first scalar to yield a first product,
a second multiplier having a second vector input and a second scalar input and configured to multiply a second vector by a second scalar to yield a second product, and
an accumulator coupled to said first multiplier and said second multiplier and configured to receive said first and second products.

18. The processing unit as recited in claim 16 further comprising an accumulator coupled to said first and second multiply-accumulate units.

19. The processing unit as recited in claim 15 wherein said first and second multipliers are divided into portions dedicated to separate lanes of a processing unit.

20. The processing unit as recited in claim 15 wherein said accumulator is configured to add said first and second products to an existing value in said accumulator.

21. The processing unit as recited in claim 15 wherein said multiply-accumulate unit is associated with a single-instruction multiple data processing unit.
